(19) United States
(12) Patent Application Publication
(10) Pub. No.: US 2026/0066534 A1
(43) Pub. Date: Mar. 5, 2026

(54) ANTENNA CELL ARRAY

(71) Applicant: Commissariat à l'Energie Atomique et aux Energies Alternatives, PARIS (FR)

(72) Inventors: Bilal OUARDI, GRENOBLE (FR); Antonio CLEMENTE, GRENOBLE (FR)

(21) Appl. No.: 19/313,447

(22) Filed: Aug. 28, 2025

(30) Foreign Application Priority Data
Aug. 30, 2024 (FR) 2409277

(51) Int. Cl. H01Q 3/30; H01Q 1/22; H01Q 15/24

(52) U.S. Cl. CPC H01Q 3/30; H01Q 1/2283; H01Q 15/24

(57) ABSTRACT

Array antenna cell comprising a semiconductor substrate; a first polarizer located on a first side of the semiconductor substrate; a second polarizer located on a second side of the semiconductor substrate, opposite to the first side; and at least one radiating element interposed between the semiconductor substrate and the second polarizer, said at least one radiating element being generally ring-shaped.

### FIELD

The present disclosure generally concerns electronic devices. The present disclosure aims in particular at radio antennas, more specifically at array antennas and, in particular, at the cells forming such arrays.

### BACKGROUND

In various applications, such as satellite communication systems and devices of communication over 5G and 6G mobile networks, it would be desirable to have electronically steerable radio antennas, be it in transmission or reflection mode, operating at sub-THz frequencies, that is, frequencies from 100 to 500 GHz.

Among the various radio antenna technologies likely to meet the needs of applications using sub-THz frequencies, phased array antennas and reconfigurable metasurfaces based on liquid crystals or in CMOS technology have in particular been provided. Phased array antennas have the advantage of allowing a precise control of the orientation of the beam emitted by the antenna and of providing access to a wide angular range. Reconfigurable metasurfaces based on liquid crystals have a greater compactness than phased array antennas, while offering similar advantages. However, phased array antennas have too high power consumptions and production costs for an integration in consumer devices, and reconfigurable metasurfaces suffer from excessive losses and from a relatively small bandwidth.

Transmitarray or reflectarray antennas have also been provided.

However, these antennas are not versatile or are limited when frequencies increase.

### SUMMARY

There exists a need to overcome all or part of the disadvantages of existing transmitarray or reflectarray antennas. It would in particular be desirable to have transmitarray antennas with a high gain, a high energy efficiency, and a decreased complexity while allowing improved phase quantization in transmission and reflection modes.

For this purpose, an embodiment provides an array antenna cell comprising:
a semiconductor substrate;
a first polarizer located on a first side of the semiconductor substrate;
a second polarizer located on a second side of the semiconductor substrate, opposite to the first side; and
at least one radiating element interposed between the semiconductor substrate and the second polarizer,
   said at least one radiating element being generally ring-shaped.

According to an embodiment, said at least one radiating element is adapted to switching between phase states in transmission mode and phase states in reflection mode.

According to an embodiment, the first polarizer and the second polarizer are rectilinear and orthogonal to each other.

According to an embodiment, the first side is a first surface of the semiconductor substrate, and the second side is a second surface of the semiconductor substrate.

According to an embodiment, the radiating element comprises at least a first, a second, a third, and a fourth distinct parts, of same dimensions, and each having, in top view, a same truncated ring shape.

According to an embodiment:
the first and the second parts are coupled by a first switch;
the second and the third parts are coupled by a second switch;
the third and the fourth parts are coupled by a third switch;
the fourth and the first parts are coupled by a fourth switch;
the first, second, third, and fourth switches being formed in the semiconductor substrate.

According to an embodiment, a same spacing separates the first and the second part, the second and the third part, the third and the fourth part, as well as the fourth and the first parts.

According to an embodiment, each of the first, second, third, and fourth parts is located on top of and in contact with the second surface of the semiconductor substrate.

According to an embodiment:
the first polarizer comprises a plurality of first conductive strips substantially parallel to one another; and
the second polarizer comprises a plurality of second conductive strips substantially parallel to one another and substantially orthogonal to the first conductive strips.

According to an embodiment, the cell further comprises:
a first insulating region interposed between the first surface of the semiconductor substrate and the first polarizer; and
a second insulating region interposed between the second surface of the semiconductor substrate and the second polarizer.

According to an embodiment, the first, second, third, and fourth parts are formed in at least one metallization level of an interconnection stack interposed between the semiconductor substrate and the second polarizer.

According to an embodiment, the radiating element is adapted to switching between two phase states in transmission mode and four phase states in reflection mode.

According to an embodiment, a first phase state in transmission mode is obtained when the first and third switches are on and the second and fourth switches are off.

According to an embodiment, a second phase state in transmission mode is obtained when the first and third switches are off and the second and fourth switches are on.

According to an embodiment, a first phase state in reflection mode is obtained when the first, second, third, and fourth switches are off.

According to an embodiment, a second phase state in reflection mode is obtained when the first, second, third, and fourth switches are on.

According to an embodiment, a third phase state in reflection mode is obtained when the first and fourth switches are off and the second and third switches are on.

According to an embodiment, a fourth phase state in reflection mode is obtained when the first and second switches are off and the third and fourth switches are on.

According to an embodiment, the radiating element is generally exclusively ring-shaped.

According to an embodiment, the radiating element has a generally circular or oval shape, or the shape of a quadrilateral, for example square or rectangular.

An embodiment provides an antenna array comprising a plurality of cells such as described hereabove.

According to an embodiment, the semiconductor substrate is common to a plurality of cells in the array.

An embodiment provides an antenna comprising an array such as described hereabove and at least one source configured to irradiate a surface of the array.

### BRIEF DESCRIPTION OF THE DRAWINGS

The foregoing features and advantages, as well as others, will be described in detail in the rest of the disclosure of specific embodiments given as an illustration and not limitation with reference to the accompanying drawings, in which:

FIG. 1 is a simplified and partial side view of an example of an array antenna of the type to which the described embodiments apply as an example;

FIG. 2A is a top view of an array antenna cell of FIG. 1;

FIG. 2B is a simplified and partial cross-section view of an array antenna cell according to the embodiment of FIG. 2A;

FIG. 2C is a simplified and partial cross-section view of an array antenna cell according to the embodiment of FIG. 2A;

FIGS. 3A and 3B are simplified and partial top views of the cell of FIG. 2A;

FIG. 4 shows, in a top view, several configurations of an element of the array antenna cell according to an embodiment;

FIG. 5 shows graphs of magnitudes and of phase shifts as a function of frequency;

FIG. 6 schematically shows different configurations of the array of FIG. 1;

FIG. 7 shows graphs of amplitude (gain in dBi) as a function of an orientation angle and at a fixed frequency.

### DETAILED DESCRIPTION OF THE PRESENT EMBODIMENTS

Like features have been designated by like references in the various figures. In particular, the structural and/or functional features that are common among the various embodiments may have the same references and may dispose identical structural, dimensional and material properties.

For the sake of clarity, only those steps and elements that are useful for understanding the described embodiments have been shown and are described in detail. In particular, embodiments of a transmitarray and reflectarray antenna cell are described hereafter. The structure and the operation of the primary source(s) of the antenna, intended to irradiate the transmitter or reflector array, will not be detailed, the described embodiments being compatible with all or most of the known primary radiation sources for transmitarray or reflectarray antennas. As an example, each primary source is adapted to generating a beam of generally conical shape irradiating all or part of the transmitter or reflector array. Each primary source for example comprises a horn antenna. As an example, the central axis of each primary source is substantially orthogonal to the mean plane of the array.

Further, methods of manufacturing the described transmitter or reflector arrays will not be detailed, the forming of the described structures being within the abilities of those skilled in the art based on the indications of the present description, for example by implementing usual printed circuit manufacturing techniques.

Unless indicated otherwise, when reference is made to two elements connected together, this signifies a direct connection without any intermediate elements other than conductors, and when reference is made to two elements coupled together, this signifies that these two elements can be connected or they can be coupled via one or more other elements.

In the following description, where reference is made to absolute position qualifiers, such as the terms “front”, “back”, “top”, “bottom”, “left”, “right”, etc., or relative position qualifiers, such as the terms “top”, “bottom”, “upper”, “lower”, etc., or orientation qualifiers, such as “horizontal”, “vertical”, etc., reference is made unless otherwise specified to the orientation of the drawings.

Unless specified otherwise, the expressions “about”, “approximately”, “substantially”, and “in the order of” signify plus or minus 10%, preferably of plus or minus 5%.

In the following description, the qualifiers “insulating” and “conductive” respectively signify, unless otherwise specified, electrically insulating and electrically conductive.

Transmitarray antennas typically comprise a plurality of elementary cells, each comprising a first antenna element irradiated by an electromagnetic field emitted by one or more focal sources, a second antenna element transmitting a modified signal to the outside of the antenna, and a coupling element interposed between the first and second antenna elements. Reflectarray antennas typically comprise a plurality of elementary cells, each comprising an antenna element irradiated by an electromagnetic field emitted by one or more sources, a reflector element, for example a ground plane, reflecting a modified signal towards the outside of the antenna, and a coupling element between the antenna element and the reflector element. Transmitarray or reflectarray antennas are, for example, formed on a PCB (printed circuit board) or CMOS (complementary metal-oxide-semiconductor) substrate. Further, each elementary cell of a reconfigurable transmitarray or reflectarray antenna comprises, for example, at least one switch, for example a switch based on a P-I-N diode or based on a phase-change material. Transmitarray or reflectarray antennas have the advantage of offering, over phased array antennas and reconfigurable metasurfaces, a better efficiency, a wider bandwidth, and/or lower production costs. However, existing transmitarray or reflectarray antennas suffer from various disadvantages, such as high transmission losses, too narrow transmit and/or receive bands, a significant complexity of implementation, etc.

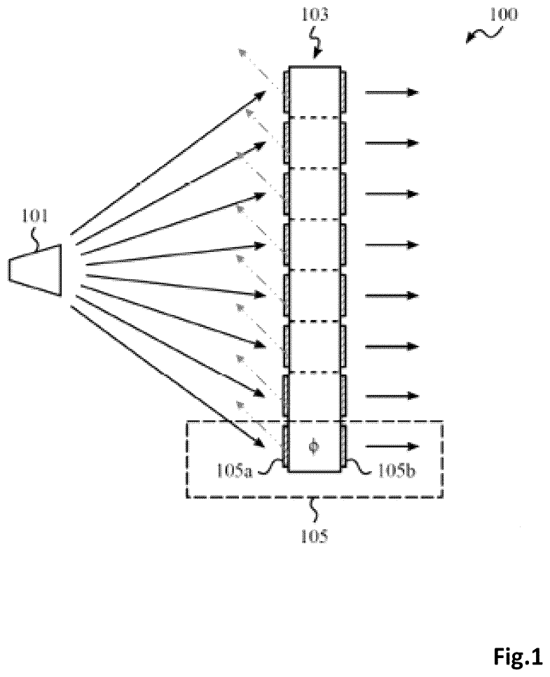

FIG. 1 is a simplified and partial side view of an example of a transmitarray antenna 100 of the type to which the described embodiments apply, as an example.

Antenna 100 typically comprises one or more primary sources 101 (a single source 101 in the shown example), placed at a focal distance F, irradiating a transmitter or reflector array 103. Source 101 may have any polarization, for example linear or circular. Array 103 comprises a plurality of elementary cells 105, for example arranged in a matrix, in rows and columns. Each cell 105 typically comprises a first antenna element 105a, located on the side of a first surface of array 103 arranged opposite primary source 101, and a second antenna element 105b, located on the side of a second surface of the array opposite to the first surface. The second surface of array 103 faces, for example, a transmission medium of antenna 100.

Each cell 105 is capable, in transmission mode, of receiving an electromagnetic radiation on its first antenna element 105a and of retransmitting this radiation from its second antenna element 105b, for example by introducing a known phase shift. In reception mode, each cell 105 is capable of receiving an electromagnetic radiation on its second antenna element 105b and of retransmitting this radiation from its first antenna element 105a with the same phase shift.

The characteristics of the beam generated by antenna 100, in particular its shape (or template) and its maximum emission direction (or pointing direction θ_0, φ_0), depend on the values of the phase shifts respectively introduced by the different cells 105 of array 103. An amplitude control may further be exerted, by each elementary cell, on the incident electromagnetic wave.

The incident electromagnetic wave has, in the example of FIG. 1, a spherical shape. Each cell receives the incident wave with a different delay since the path differs between the source and each cell. The phase compensation ψₘₙ within each cell 105 of coordinates xₘₙ, yₘₙ can be expressed according to the following formulas:

$${ψ}_{m n} = {Δφ}_{s p} - \frac{2 π}{λ} ( sin ( {θ}_{0} ) cos ( {φ}_{0} ) {x}_{m n} + sin ( {θ}_{0} ) sin ( {φ}_{0} ) {y}_{m n} ) \qquad [ MATH 1 ]$$

$${Δφ}_{s p} = k {r}_{m n} = \frac{2 π}{λ} \sqrt{{x}_{m n}^{2} + {y}_{m n}^{2} + {F}^{2}} \qquad [ MATH 2 ]$$

Δφₛₚ being the spatial delay, k being the wave number, rₘₙ being the distance between the source and the cell.

Transmitarray or reflectarray antennas have as advantages, among others, of exhibiting a good energy efficiency and of being relatively simple, inexpensive, and compact. This mainly results from the fact that the transmitter or receiver arrays can be formed in planar technology, generally on printed circuit boards.

The present description more specifically aims at reconfigurable array antennas 103 to allow the use of array 103 in transmitter mode (solid arrows) or in reflector mode (dotted arrows). Array 103 is said to be reconfigurable when elementary cells 105 are electronically controllable, individually, to modify their phase shift value. This enables to dynamically modify the characteristics of the beam generated by the antenna, and in particular to modify its pointing direction without mechanically displacing the antenna or a portion of the antenna by means of a motorized element.

Reconfigurable antennas use PIN (Positive Intrinsic Negative) diodes, which may or may not be coupled with PATCH-type antennas, to change configuration when using waves below ten gigahertz. However, some of these solutions only work in transmission or reflection mode, or cannot be used for sub-THz frequencies because the size of the PIN diodes in this case is in the order of millimeters, which is incompatible with the wavelengths used. Such solutions also have the disadvantage of being unstable in reflection mode due to the use of two resonant modes. Finally, these solutions only offer a phase quantization limited to two states in reflection or transmission mode. They also suffer from limited aperture efficiency and a narrow bandwidth.

To overcome these disadvantages, the embodiments provide using one or more array antenna cells comprising:
a semiconductor substrate;
a first polarizer located on a first side of the semiconductor substrate;
a second polarizer located on a second side of the semiconductor substrate, opposite to the first side; and
at least one radiating element interposed between the semiconductor substrate and the second polarizer, said at least one radiating element being generally ring-shaped.

Unlike cases where the radiating element has a conductive portion arranged along a diagonal of a circle, which only operate in transmission mode, the described embodiments enable to alternate between transmission phase states and reflection phase states.

This enables to obtain, for example, a phase quantization with two states in transmission mode and four states in reflection mode.

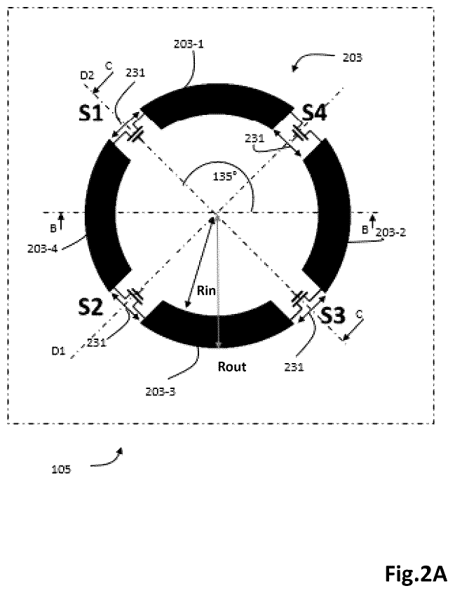

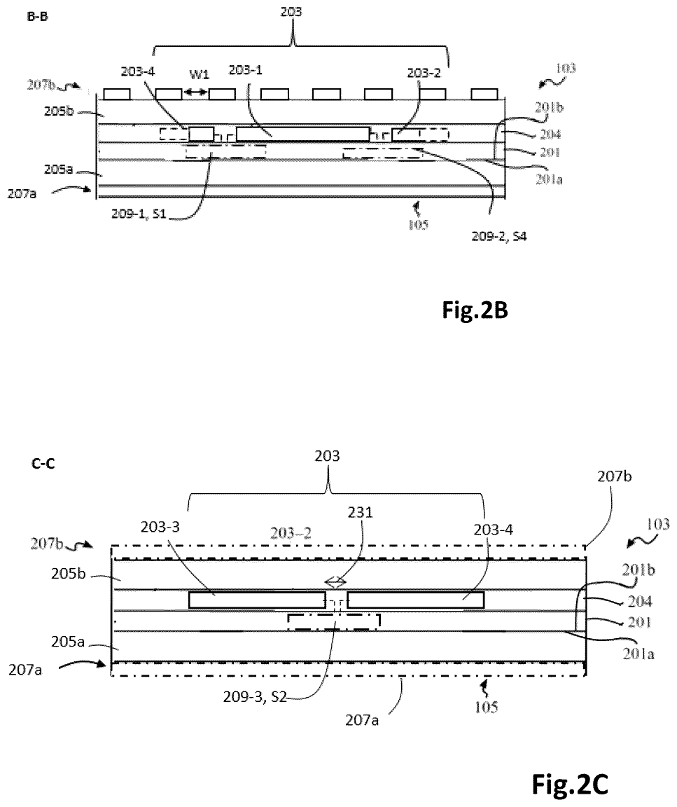

FIG. 2A is a top view of an array antenna cell 105 of FIG. 1.

In this example, antenna cell 105 comprises a semiconductor substrate, a first polarizer located on a first side of the semiconductor substrate, a second polarizer located on a second side of the semiconductor substrate, opposite to the first side; and at least one radiating element 203 interposed between the semiconductor substrate and the second polarizer. In the shown example, the polarizers as well as the semiconductor substrate are made transparent for the sake of clarity, to be able to better distinguish radiating element 203.

In the shown example, radiating element 203 is generally ring-shaped. In other words, this signifies that radiating element 203 is in the form of a ring, continuous or not, and that it comprises no branch extending perpendicularly from the periphery of the ring toward the inside of the ring. In other words, radiating element 203 does not have a “T”-shaped structure with the bottom of the “T” pointing toward the center of the ring. The ring of FIG. 2A comprises no conductive structure, continuous or not, which mainly extends along one of these radii or along one of these diameters. Radiating element 203 is, in other words, in the form of a continuous or discontinuous ring.

In the shown example, the ring has a circular shape, but in other examples it may have an oval, square, or rectangular shape, or be in the form of a quadrilateral, or be slightly deformed by the manufacturing methods.

In the shown example, radiating element 203 comprises a first, a second, a third, and a fourth parts 203-1, 203-2, 203-3, 203-4 which are distinct, that is, they are separate from one another. In the shown example, the first, second, third, and fourth parts 203-1, 203-2, 203-3, 203-4 are of same dimensions, that is, they could be superimposed identically, to within manufacturing dispersions. This enables to integrate switches and dynamically change the impedance of the structure with a defined resolution.

In the shown example, parts 203-1 and 203-3 are diametrically opposite with respect to the center of the ring formed by radiating element 203. Similarly, parts 203-2 and 203-4 are diametrically opposite.

In this example, each of the first, second, third, and fourth parts 203-1, 203-2, 203-3, 203-4 has, in top view, a same ring arc, that is, truncated ring, shape. None of these parts comprises a branch having its elongation direction directed towards the center of the ring, for example. This allows the use of the cell in transmission or in reflection mode. Indeed, if the radiating element comprised a conductive track extending along a diagonal of the ring, for example with a “T” shape, then this diagonal track of the radiating element would act as a polarization rotator by electromagnetic excitation along the direction of this diagonal. The use of this type of radiating element with a diagonal track, coupled to polarizers orthogonal to each other, does not allow the use in reflection, but only in transmission.

In the shown example, parts 203-4, 203-1 are coupled by a first switch S1, parts 203-1, 203-2 are coupled by a second switch S4, parts 203-2, 203-3 are coupled by a third switch S3, and finally parts 203-3, 203-4 are coupled by a fourth switch S2.

When one of the switches is in the on state, the parts to which it is coupled are electrically connected, which amounts to increasing the arc length of the ring, in other words, this amounts to increasing the non-discontinuous arc length of the ring. Such an architecture makes it possible to obtain reconfigurable cells suitable for switching between at least two phase states in transmission mode and four phase states in reflection mode.

In a non-illustrated example, not all switches are present and some of the adjacent parts are not coupled together by a switch.

Switches S1, S2, S3, and S4 are preferably controlled substantially simultaneously to the off or on state.

In an example, a same spacing 231, that is, a spacing of same size, separates parts 203-1 and 203-2, parts 203-2 and 203-3, parts 203-3 and 203-4, and parts 203-4 and 203-1. In other words, parts 203-1, 203-2, 203-3, and 203-4 are homogeneously distributed along the periphery of the ring. This enables to obtain phases having a constant phase shift between them and maximize the transmission or the reflection of the electromagnetic wave.

In FIG. 2A, a cross-section plane B-B, perpendicular to radiating element 203, runs through an axis of symmetry of parts 203-4 and 203-2. Further, another cross-section plane C-C, perpendicular to radiating element 203, runs through the center of switches S1 and S3, that is, through the center of the spacing 231 separating the parts surrounding switches S1 and S3. Plane C-C is, for example, oriented at 135° with respect to plane B-B, the angles being measured in the counterclockwise direction.

The line D1 joining the spacing between parts 203-1 and 203-2 and the spacing between parts 203-3 and 203-4 has, for example, an angle of 45° with respect to plane B-B. The line D2 joining the spacing between parts 203-1 and 203-4 and the spacing between parts 203-3 and 203-2 (in other words, the line common to plane C-C and to the horizontal plane) has, for example, an angle of 135° with respect to plane B-B.

In an example, the first, second, third, and fourth switches S1, S4, S3, S2 are formed in the semiconductor substrate.

As an example, switches S1, S2, S3, and S4 are MOS-type transistors, PCMs (Phase Change Memory Switch) transistors, or varactors, etc.

In an example, the first, second, third, and fourth parts 203-1, 203-2, 203-3, 203-4 are formed in an electrically-conductive material, such as a metal, for example copper, or a metal alloy, or a conductive organic material or a material comprising carbon nanotubes or graphene, or even a doped metal oxide such as tin oxide or zinc oxide.

In an example, the thickness of the first, second, third, and fourth parts 203-1, 203-2, 203-3, 203-4 is in the range from 15 to 100 μm.

In an example, parts 203-1, 203-2, 203-3, 203-4 have a width in the range from an inner radius of the ring Rin to an outer radius of the ring Rout. Rin and Rout are, for example, in the range from 135 μm to 175 μm.

In an example, the thickness of the parts of radiating element 203 is in the range from 30 to 150 μm, for example 35 μm.

FIG. 2B is a simplified and partial cross-section view of an array antenna cell according to the embodiment of FIG. 2A. More particularly, FIG. 2B shows the view along cross-section plane B-B.

In the shown example, elementary cell 105 comprises semiconductor substrate 201. Substrate 201 is, for example, a wafer or a piece of wafer made of a semiconductor material, for example silicon. Semiconductor substrate 201 is, for example, of CMOS (“Complementary Metal-Oxide-Semiconductor”) type. In this case, substrate 201 comprises, for example, one or more electronic components formed in CMOS technology, for example at least one MOS (metal-oxide-semiconductor) transistor. As a variant, substrate 201 may be made of a semiconductor material different from silicon, for example a III-V semiconductor material such as gallium nitride (GaN) or gallium arsenide (GaAs). In an example, substrate 201 is made of quartz.

In the illustrated example, elementary cell 105 comprises radiating element 203 with its shown parts 203-1, 203-2, and 203-2 located on semiconductor substrate 201. In this example, the parts of the radiating element are more precisely formed in an interconnection stack or array 204 located on top of and in contact with a surface 201b of substrate 201 (the upper surface of substrate 201, in the orientation of FIG. 2B). In the shown example, interconnection stack 204 comprises a stack of alternating conductive layers and insulating layers. As an example, the insulating layers are made of silicon oxide (SiO₂), and have a thickness, for example, in the order of 4 μm. The portions of the parts 203-1, 203-2, and 203-4 of radiating element 203 which are cut by plane B-B are symbolized by rectangles in dotted lines, and the portions recessed with respect to this plane B-B are symbolized by a solid line in FIG. 2B. The parts 203-1, 203-2, 203-3, and 203-4 of radiating element 203 are, for example, metal layers, also called metallization levels. Although this has not been detailed in the drawings, interconnection stack 204 comprises, for example, in addition to the parts 203-1, 203-2, 203-3, and 203-4 of radiating element 203, conductive tracks formed in the conductive layers and conductive vias, for example metal vias, interconnecting conductive tracks located in different conductive layers.

The parts of radiating element 203 are formed in at least one of the conductive layers of interconnection stack 204. In the shown example, the parts 203-1, 203-2, 203-3, and 203-4 of radiating element 203 are formed in a single metallization level, for example in the upper metallization level, also called last metallization level, that is, the metallization level most distant from semiconductor substrate 201. This example is however not limiting, and the parts 203-1, 203-2, 203-3, and 203-4 of radiating element 203 may, as a variant, be formed in a metallization level other than the last metallization level and/or in a plurality of metallization levels of stack 204. Further, in the shown example, the upper metallization level is coated with an insulating layer of stack 204. This example is however not limiting, and the upper metallization level may, as a variant, be flush with the upper surface of stack 204.

Further, although FIG. 2B illustrates a case in which the parts of radiating element 203 are formed in the same metallization level of interconnection stack 204, this example is not limiting, and one of the parts of the radiating element 203 may, as a variant, be formed in a metallization level different from that in which the other radiating element is formed. For example, the parts 203-1 and 203-3 of radiating element 203 are formed in a first metallization level of stack 204, for example the upper metallization level, and the parts 203-2 and 203-4 of radiating element 203 are formed in a second metallization level separated from the first metallization level by one of the insulating layers of stack 204, for example a lower metallization level interposed between substrate 201 and the last metallization level.

The parts 203-1, 203-2, 203-3, and 203-4 of radiating element 203 are, for example, of “on-chip antenna” type.

In the shown example, elementary cell 105 further comprises insulating regions 205a and 205b located on either side of semiconductor substrate 201. In this example, insulating region 205a covers a surface 201a of semiconductor substrate 201 (the lower surface of substrate 201, in the orientation of FIG. 2B) opposite to surface 201b. Insulating region 205a is, for example, more precisely located on top of and in contact with the surface 201a of substrate 201.

In the shown example, insulating region 205b is located on substrate 201 and the parts 203-1, 203-2, 203-3, and 203-4 of radiating element 203. In this example, insulating region 205b is more precisely located on top of and in contact with the upper surface of interconnection stack 204. In the illustrated example where the last metallization level is coated with an insulating layer, insulating region 205b is located on top of and in contact with this insulating layer. In the case where the last metallization level is flush with the upper surface of interconnection stack 204, insulating region 205b is located on top of and in contact with the last metallization level of stack 204.

As an example, substrate 201 and interconnection stack 204 form an integrated circuit chip, more specifically a CMOS-type integrated circuit chip.

Insulating regions 205a and 205b are, for example, each made of a material having a relative dielectric permittivity εᵣ, also called “dielectric constant”, in the range from 2 to 4. Insulating regions 205a and 205b are, for example, formed in one or more insulating layers of a printed circuit board. As a variant, each insulating region 205a, 205b may be made of quartz, of fused silica, etc. As an example, each insulating region 205a, 205b has a thickness in the range from 100 to 300 μm.

In the illustrated example, elementary cell 105 further comprises polarizer structures 207a and 207b located on either side of semiconductor substrate 201. In this example, polarizer 207a is located on the side of surface 201a of semiconductor substrate 201. In the shown example, polarizer 207a coats a surface of insulating region 205a opposite to semiconductor substrate 201 (the lower surface of insulating region 205a, in the orientation of FIG. 2B).

In the shown example, polarizer 207b is located on the side of surface 201b of semiconductor substrate 201. In this example, polarizer 207b coats a surface of insulating region 205b opposite to semiconductor substrate 201 (the upper surface of insulating region 205b, in the orientation of FIG. 2B).

As an example, polarizers 207a and 207b are respectively part of the first and second antenna elements 105a and 105b of elementary cell 105. This corresponds, for example, to a case where polarizer 207a is arranged opposite primary source 101 and polarizer 207b faces the outside environment, or transmission environment, of antenna 100. As a variant, polarizers 207a and 207b may respectively form part of the second and first antenna element, 105b and 105a of elementary cell 105. This corresponds, for example, to a case where polarizer 207a faces the outside medium, or transmission medium, of antenna 100 and where polarizer 207b is arranged opposite primary source 101. In any case, the polarizer located on the source side is polarized in the same direction as the source. In practice, the polarization of the wave to be transmitted or received is fixed and the polarizers are rotated so as to comply with this constraint.

In the case where insulating regions 205a and 205b are formed in one or more insulating layers of a printed circuit board, parts 203-1, 203-2, 203-3, and 203-4 and polarizers 205a and 205b are, for example, formed in metallic conductive layers, also called metallization levels, of the printed circuit board.

In the shown example, switches S1 and S4 are formed in semiconductor substrate 201, for example in regions 209-1 and 209-2 of substrate 201 symbolized, in FIG. 2B, by rectangles in dotted lines. Switches S1 and S4 are for example connected to the corresponding parts 203-1, 203-2, 203-3, and 203-4 of radiating element 203 by conductive vias and/or conductive tracks of interconnection stack 204 shown in dotted lines. These connections have not been detailed in FIG. 2B so as not to overload the drawing.

As an example, semiconductor substrate 201 is part of an integrated circuit chip mechanically bonded to the printed circuit board comprising insulating regions 205a and 205b and polarizers 207a and 207b by techniques implemented in surface mounting of electronic components, for example by soldering or via solder balls, for example on the side of region 205a.

Although FIG. 2B illustrates an example in which a single elementary cell is formed inside and on top of a same substrate, this example is not limiting. More generally, all or part of the elementary cells 105 of transmitter array 103 may be formed inside and on top of the same substrate. Further, although this has not been shown in FIG. 2B, control and power supply circuits may be provided in the printed circuit board. These circuits may, for example, comprise shift registers, flip-flops, buffer circuits, etc., adapted to controlling the switches of the elementary cells 105 to the off or on state depending on the desired orientation of the beam emitted or received by antenna 100.

As an example, transmitter array 103 may further comprise circuits for controlling and biasing (not shown in FIG. 2B) the switches of elementary cells 105. Generally, transmitter array 103 may comprise any number of control and bias circuits associated with any number of assemblies of elementary cells, each comprising a plurality of elementary cells formed on a same semiconductor substrate.

FIG. 2C is a simplified and partial cross-section view of an array antenna cell 105 according to the embodiment of FIG. 2A. More particularly, FIG. 2B shows the view along cross-section plane C-C.

In the shown example, polarizers 207a and 207b are shown in the form of blocks for more clarity.

In this example, parts 203-3 and 203-4 are shown in solid lines because they are arranged in recessed manner with respect to plane C-C.

In the shown example, no part of radiating element 203 is arranged in plane C-C. The same applies to cross-section planes rotated by 90° or 270° with respect to plane C-C. In the case of these planes rotated by 90° or 270°, no part of radiating element 203 would appear to be cut since no part of the radiating element extends mainly along all or part of a diameter of radiating element 203.

In the shown example, spacing 231 separates the respective ends of parts 203-3 and 203-4 facing each other. Spacing 231 is, for example, in the range from 10 to 100 μm, preferably approximately 50 μm. Spacings 231 enable to envisage several configurations for the ring and also enable to ensure a degree of electromagnetic isolation between adjacent parts of radiating element 203.

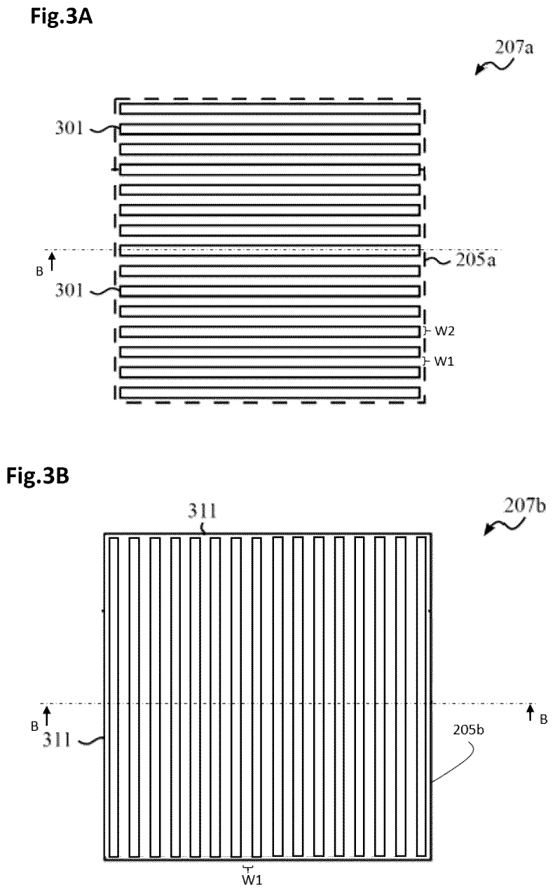

FIGS. 3A and 3B are simplified and partial top views of the cell of FIG. 2A. More specifically, in FIG. 3A, only element 207a is shown by transparency, the other parts of the cell not being shown, for more clarity.

The cross-section plane B-B of FIGS. 2A to 2B is shown in FIGS. 3A and 3B.

FIG. 3A more precisely illustrates an example of the structure of polarizer 207a arranged on the side of surface 201a of semiconductor substrate 201.

In the shown example, polarizer 207a comprises a plurality of separate strips 301 located beneath and in contact with insulating region 205a symbolized, in FIG. 3A, by a square in dotted lines. In an example, strips 301 have a width W2 in the range from 80 to 200 μm. In this example, strips 301 are substantially parallel to each other and with a main elongation parallel to plane B-B. In the shown example, strips 301 are spaced apart in substantially regular manner, at a constant pitch W1. In an example, W1 is equal to W2. Strips 301 are, for example, made of a conductive material, for example a metal such as copper, or a metal alloy. In an example, pitch W1 is in the range from 80 to 200 μm.

When antenna 100 is operating in transmission mode, polarizer 207a is adapted to controlling the transmission, to radiating element 203, of waves originating from primary source 101. Polarizer 207a more specifically enables to transmit, toward radiating element 203, incident waves having a polarization substantially identical to that of polarizer 207a, that is, a linear polarization substantially orthogonal to strips 301, and to reflect incident waves having a polarization different from that of polarizer 207a, that is, a linear polarization parallel to strips 301.

FIG. 3B illustrates in particular an example of a structure of polarizer 207b arranged on the side of surface 201b of semiconductor substrate 201.

In the shown example, polarizer 207b comprises a plurality of strips 311 located on top of and in contact with insulating region 205b. In this example, strips 311 are substantially parallel to one another and have dimensions W2 similar to those of strips 301. Strips 311 are, for example, substantially orthogonal to the strips 301 of polarizer 207a. In the shown example, strips 311 are spaced apart in substantially regular manner, at a constant pitch, for example pitch W1. Strips 311 are, for example, made of a conductive material, for example a metal such as copper, or a metal alloy. For the simplification of the manufacturing of elementary cell 105, the strips 311 of polarizer 207b are, for example, made of the same material as the strips 301 of polarizer 207a.

Strips 301 have their longitudinal extension direction oriented at 90° with respect to the longitudinal extension of strips 311. In an example, strips 301 and 311 have their longitudinal extension direction oriented with an angle of, respectively, 45° and −45° with respect to line D2.

When antenna 100 is operating in transmission mode, polarizer 207b is, for example, adapted to controlling the transmission, towards the outside medium, of waves originating from radiating element 203. Polarizer 207b more specifically enables to transmit, towards the outside medium, incident waves having a polarization substantially identical to that of polarizer 207b, that is, a linear polarization substantially orthogonal to strips 311, and to reflect incident waves having a polarization different from that of polarizer 207b, that is, a linear polarization parallel to strips 311.

An advantage of radiating element 203 lies in the fact that it enables to obtain more phase states in reflection and transmission modes, and thus a more precise control of the orientation of the beam emitted by antenna 100.

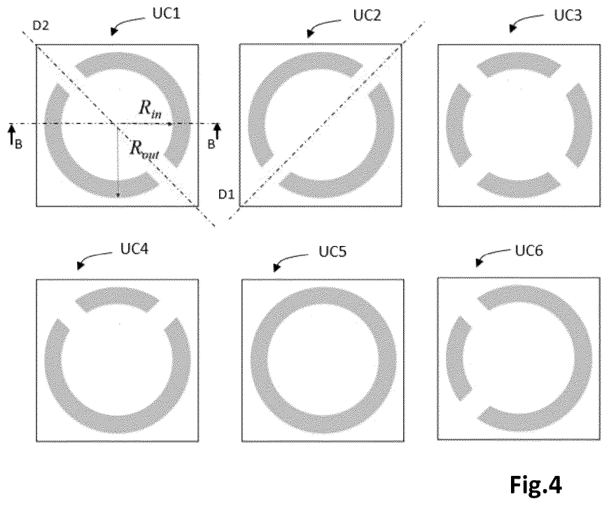

FIG. 4 shows, in a top view, several configurations of an element of the array antenna cell according to an embodiment. More specifically, FIG. 4 illustrates two configurations UC1 and UC2 of radiating element 203 used in transmission mode, and four configurations UC3, UC4, UC5, and UC6 used in reflection mode, for example.

In configuration UC1, a first phase state in transmission mode is obtained when switches S1 and S3 are off and switches S4 and S2 are on.

In configuration UC2, switches S1 and S3 are on, and switches S4 and S2 are off, which enables to obtain a second phase state in transmission mode.

In the case of configurations UC1 and UC2, the radiating element takes the form of two semicircles facing each other and separated by a non-conductive line oriented along axis D2 and, respectively, axis D1. These two semicircles act as a rotator forming a conductive pseudo-diagonal arranged respectively along axes D2 and D1. This pseudo-diagonal causes a polarization rotation which, in conjugation with polarizers 207a and 207b, allows transmission.

Configurations UC1 and UC2 enable to limit insertion losses while ensuring a wide bandwidth. They further enable to obtain two different stable phase states with a relative phase difference of approximately 180° and to be able to ensure a phase modulation in transmission mode.

In configuration UC3, switches S1, S2, S3, and S4 are off, which enables to obtain a first phase state in reflection mode. In this configuration, the radiating element takes a shape comprising four ring arcs, or as shown, arcs of a circle, separated by non-conductive spacers arranged at the intersection of the ring with axes D2 and D1.

In configuration UC4, switches S1 and S2 are off, and switches S4 and S3 are on, which enables to obtain a second phase state in reflection mode. In this configuration, the radiating element takes a generally circular or ring shape, with two non-conductive spacings arranged at the intersection of the ring with axes D2 and D1 only on the upper part (in the orientation of FIG. 4) of the ring.

In configuration UC5, switches S1, S2, S3, and S4 are on, which enables to obtain a third phase state in reflection mode. In this configuration, the radiating element takes a fully circular, or full ring, shape, that is, the ring is entirely continuous.

In configuration UC6, the first and second switches S1 and S4 are off, and switches S3 and S2 are on, which enables to obtain a fourth phase state in reflection mode. In this configuration, the radiating element takes a generally circular shape with two non-conductive spacers arranged at the intersection of the ring with axis D2 only on the upper part (in the orientation of FIG. 4) of the ring and at the intersection of the ring with axis D1 only on the lower part of the ring.

Configurations UC3, UC4, UC5, and UC6 allow the elementary cells to operate as individual resonators with no polarization rotation, which, in conjunction with polarizers 207a and 207b, causes a reflection of the incident wave. According to the implemented configuration, different modes of the incident wave are selected, which enables to obtain four different phase states in reflection mode. Each of the four phase states is separated by a 90° phase difference. States UC3, UC4, UC5, and UC6 may also be used to form a reflector array with two phase states separated by 180°, that is, with a relative 180° phase difference.

Configurations UC3, UC4, UC5, and UC6 further enable to obtain limited reflection losses while ascertaining a wide frequency bandwidth. The aperture efficiency is also improved.

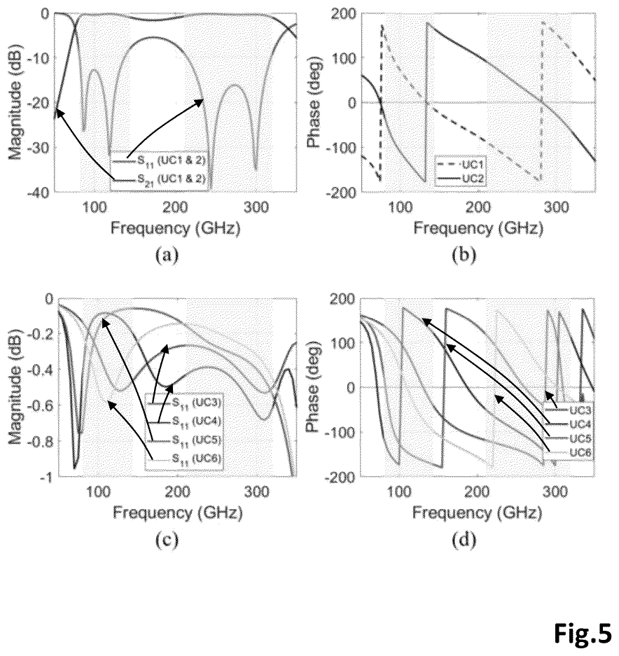

FIG. 5 shows graphs of the amplitude and phase shift as a function of frequency for a given cell. More specifically, FIG. 5 comprises a graph a) showing the magnitude in dB, as a function of the frequency expressed in GHz, of the S11 parameters in configurations UC1 and UC2, and S21 in configurations UC1 and UC2. FIG. 5 also comprises a graph b), representing the phase shift expressed in degrees (deg) for configurations UC1 and UC2 as a function of the frequency expressed in GHz. FIG. 5 further comprises a graph c) representing the magnitude in dB of the S11 parameter as a function of the frequency expressed in GHz in configurations UC3, UC4, UC5, and UC6. FIG. 5 finally comprises a graph d), representing the phase shift expressed in degrees (deg) as a function of frequency expressed in GHz for configurations UC3, UC4, UC5, and UC6.

These graphs show that, for strips W and D, the obtained 1-dB bandwidth is 63 GHZ, that is, 56% at 112.5 GHz (81-144 GHz). For strip H, the obtained 1-dB bandwidth is 116 GHZ, that is, 44.2% of 262 GHz (204-320 GHz).

In graph b), which represents transmission modes UC1 and UC2, two phase states are obtained and their respective differences remain relatively stable over the frequency range from a few GHz to 400 GHz.

In graph d), which represents the reflection modes, that is, configurations UC3, UC4, UC5, and UC6, four phase states are obtained and the difference between them remains relatively stable over the frequency range from a few GHz to 400 GHz. The four phase states obtained are, at a given frequency, 0°, 90°, 180°, and 270°.

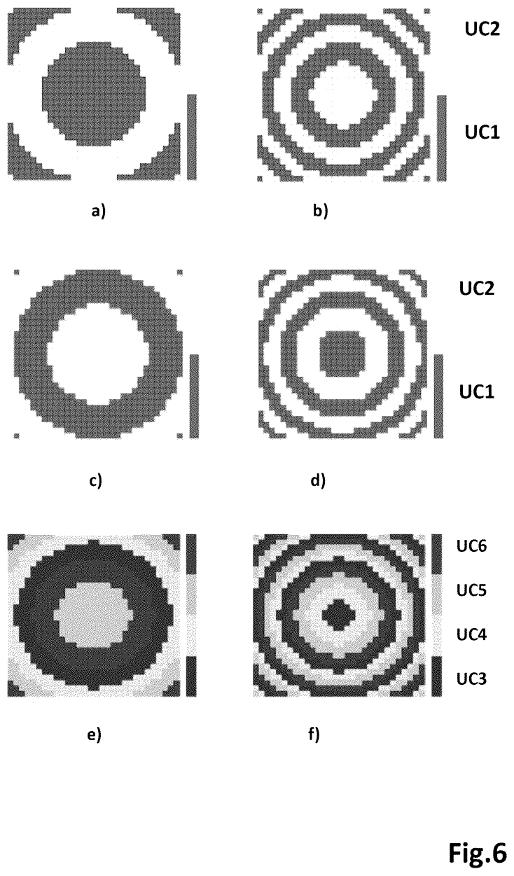

FIG. 6 schematically shows different configurations of the array of FIG. 1. More particularly, FIG. 6 comprises six representations a), b), c), d), e) and f) showing different configurations of the cells in array 103 in front view. In this example, the array is of 30 by 30 cells.

In representations a) and b), the array operates in transmission mode, and in representations c) and d), the array operates in reflection mode. In these representations a), b), c) and d), the cells shown as dark are in configuration UC1 and the cells shown as light are in configuration UC2.

In representations a) and b), the array operates in transmission mode at frequencies of 110 and 280 GHz, respectively. In representations c) and d), the array operates in reflection mode respectively at frequencies of 110 and 280 GHz.

The configurations of the cells in representations a) and b) correspond to concentric rings centered on the center of the array. Each ring corresponds to one of configurations UC1 or UC2. The higher the frequency (that is, passing from representation a) to representation b)), the more the number of rings increases and the more their width decreases.

The cell configurations in representations c) and d) are the opposite of those in representations a) and b), respectively. In other words, if in representations a) and b), a cell is in configuration UC1, then in representations c) and d), this same cell is controlled to be in configuration UC2. Conversely, if in representations a) and b), a cell is in configuration UC2, then, in representations c) and d), this same cell is controlled to be in configuration UC1.

Representations d) and e) correspond to configurations of the array in reflection mode for frequencies, respectively, of 110 and 280 GHz using configurations UC3, UC4, UC5, and UC6.

The configurations of the cells in representations e) and f) correspond to concentric rings centered on the center of the array. Each ring corresponds to a configuration of the cells from among UC3, UC4, UC5, or UC6. The higher the frequency (that is, passing from representation e) to representation f)), the more the number of rings increases and the more their respective widths decreases. In the examples shown in e) and f), the configurations of the different rings periodically follow one another between a first ring with its cells in configuration UC3, after which a second adjacent ring located immediately outside the first ring has its cells configured in UC4, then a third adjacent ring located immediately outside the second ring has its cells configured in UC5, and a fourth adjacent ring located immediately outside the third ring has its cells configured in UC6. The next ring, outside the fourth ring, returns to a configuration UC3. The next rings follow a same sequence from configuration UC3 to configuration UC6, and so on.

By comparing the reflection gains between examples c) and e) or d) and f), a gain improvement greater than 10 points is obtained by using configurations UC3, UC4, UC5, and UC6 as compared with the use of configurations UC1 and UC2 alone. Quantization losses are thus decreased from 3 dB to 0.8 dB.

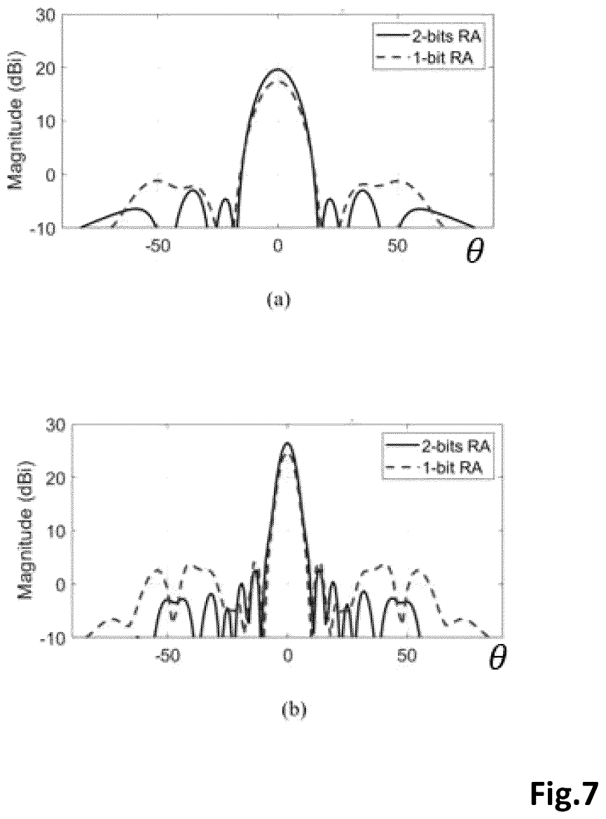

FIG. 7 shows graphs of the amplitude (gain in dBi) as a function of angle θ and as a function of frequency. More particularly, in graphs a) and b) of FIG. 7, the dotted lines represent cases where only configurations UC1 and UC2 are used in reflection mode (1-bit RA) for frequencies of 120 GHz and 300 GHz, respectively. The solid lines represent cases where configurations UC3, UC4, UC5, and UC6 are used in reflection mode (2-bit RA) for frequencies of 120 GHz and 300 GHz, respectively.

In cases a) and b) of FIG. 7, the central peak has a higher amplitude for configurations UC3, UC4, UC5, and UC6. Further, the amplitudes at angles located beyond 10° are more attenuated in the case where configurations UC3, UC4, UC5, and UC6 are used.

Various embodiments and variants have been described. Those skilled in the art will understand that certain features of these various embodiments and variants may be combined, and other variants will occur to those skilled in the art. In particular, those skilled in the art are capable of adapting the number of parts 203-1, 203-2, 203-3, and 203-4, for example to have a number greater than four thereof, as well as the number of switches S1, S2, S3, and S4 of radiating element 203, according to the targeted application. Those skilled in the art are also capable of selecting the length of each part 203-1, 203-2, 203-3, and 203-4 according to the desired phase states.

Finally, the practical implementation of the described embodiments and variants is within the abilities of those skilled in the art based on the functional indications given hereabove. In particular, those skilled in the art are capable of providing integrating into semiconductor substrate 201 electronic components such as power amplifiers, control circuits, a memory, or a processing unit enabling to control the off or on states of the various switches of the radiating element, etc.

What is claimed is:

1. Array antenna cell comprising:
a semiconductor substrate;
a first polarizer located on a first side of the semiconductor substrate;
a second polarizer located on a second side of the semiconductor substrate, opposite to the first side; and
at least one radiating element interposed between the semiconductor substrate and the second polarizer,
said at least one radiating element being generally ring-shaped.

2. Cell according to claim 1, wherein said at least one radiating element is adapted to switching between phase states in transmission mode and phase states in reflection mode.

3. Cell according to claim 1, wherein the first polarizer and the second polarizer are rectilinear and orthogonal to each other.

4. Cell according to claim 1, wherein the first side is a first surface of the semiconductor substrate, and the second side is a second surface of the semiconductor substrate.

5. Cell according to claim 1, wherein the radiating element comprises at least a first, a second, a third, and a fourth distinct parts, of same dimensions, and each having, in top view, a same truncated ring shape.

6. Cell according to claim 5, wherein:
the first and the second parts are coupled by a first switch;
the second and the third parts are coupled by a second switch;
the third and the fourth parts are coupled by a third switch;
the fourth and the first parts are coupled by a fourth switch;
the first, second, third, and fourth switches being formed in the semiconductor substrate.

7. Cell according to claim 6, wherein a same spacing separates the first and the second part, the second and the third part, the third and the fourth part, as well as the fourth and the first parts.

8. Cell according to claim 5, wherein each of the first, second, third, and fourth parts is located on top of, and in contact with, the second surface of the semiconductor substrate.

9. Cell according to claim 8, wherein:
the first polarizer comprises a plurality of first conductive strips substantially parallel to one another; and
the second polarizer comprises a plurality of second conductive strips substantially parallel to one another and substantially orthogonal to the first conductive strips.

10. Cell according to claim 3, further comprising:
a first insulating region interposed between the first surface of the semiconductor substrate and the first polarizer; and
a second insulating region interposed between the second surface of the semiconductor substrate and the second polarizer.

11. Cell according to claim 5, wherein the first, second, third, and fourth parts are formed in at least one metallization level of an interconnection stack interposed between the semiconductor substrate and the second polarizer.

12. Cell according to claim 2, wherein the radiating element is adapted to switching between two phase states in transmission mode and four phase states in reflection mode.

13. Cell according to claim 6, wherein a first phase state in transmission mode is obtained when the first and third switches are on and the second and fourth switches are off.

14. Cell according to claim 6, wherein a second phase state in transmission mode is obtained when the first and third switches are off and the second and fourth switches are on.

15. Cell according to claim 6, wherein a first phase state in reflection mode is obtained when the first, second, third, and fourth switches are off.

16. Cell according to claim 6, wherein a second phase state in reflection mode is obtained when the first, second, third, and fourth switches are on.

17. Cell according to claim 6, wherein a third phase state in reflection mode is obtained when the first and fourth switches are off and the second and third switches are on.

18. Cell according to claim 6, wherein a fourth phase state in reflection mode is obtained when the first and second switches are off, and the third and fourth switches are on.

19. Cell according to claim 1, wherein the radiating element is generally exclusively ring-shaped.

20. Cell according to claim 1, wherein the radiating element has a general circular or oval shape, or a general quadrilateral shape, for example square or rectangular.

21. Antenna array comprising a plurality of cells according to claim 1.

22. Array according to claim 1, wherein the semiconductor substrate is common to a plurality of cells in the array.

23. Antenna comprising an array according to claim 21 and at least one source configured to irradiate a surface of the array.
